(19) United States
(12) Patent Application Publication
(10) Pub. No.: US 2001/0015512 A1
(43) Pub. Date: Aug. 23, 2001

(54) Injection-molding apparatus for molding thermoplastic material containers

(76) Inventor: Antonio Fontana, Carpi (IT)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 09/784,717

(22) Filed: Feb. 15, 2001

(30) Foreign Application Priority Data
Feb. 17, 2000 (IT) M02000A000025

(51) Int. Cl. B29C 45/36; B29C 45/73

(52) U.S. Cl. 264/328.1; 425/552; 425/577

(57) ABSTRACT

An injection-molding apparatus for molding containers made of thermoplastic material for fluid products, is of the type that comprises a frame for supporting a mold constituted by a female mold part and a corresponding male plug which can be coupled axially, an interspace for molding at least one container being formed between the female mold part and the male plug, a feeding circuit for feeding the thermoplastic material which is associated with the mold and is provided with an injection device for injecting the material into the interspace, a circuit for cooling the mold for the setting of the injected material so as to obtain the container, and automatic centering elements for centering the male plug with respect to the female mold part, which are associated with the mold and operate alternatively.

### BACKGROUND OF THE INVENTION

The present invention relates to an injection-molding apparatus for molding containers made of thermoplastic material, particularly single-dose containers for fluid products, such as pharmaceutical, medical and cosmetic products.

Molds for forming said containers are known being substantially constituted by a female mold part in which one or more cavities are provided; corresponding male plugs can be inserted in said cavities, which are equal in number to the containers molded in each cycle.

An interspace remains between the internal surface of the cavities and the external surface of the corresponding male plugs, and the material to be molded is injected into said interspace.

The shape and the thickness of the interspace determine both the shape and the thickness of the walls of the containers to be produced.

It is noted that the thickness of the walls of containers such as single-dose bottles for pharmaceutical or cosmetic products is very small, since it can be as low as 0.05-0.1 mm, and requires very narrow tolerance ranges.

On the one hand, the container must have deformability and flexibility characteristics which allow the user to extract from it all of the product contained therein; on the other hand, it must ensure the preservation of the product in intact and unaltered conditions.

These conventional mold types are not free from drawbacks, including the fact that they do not ensure exact centering of both the male plug and the female mold part with respect to each other.

The male plug in fact loses alignment and cambers inwardly with respect to the female mold, and this changes the thickness of the interspace formed between the two mold parts and therefore the thickness of the walls of the molded container, which not only may assume values outside the allowed tolerance range but may even end up with having flaws, such as from hollows and/or cavities.

Accordingly, an increase in production rejects is noted, and recovery of the discarded material is often difficult and onerous, entailing an evident waste of materials and energy and an increase in production times and costs.

### SUMMARY OF THE INVENTION

The aim of the present invention is to eliminate the above-noted drawbacks of conventional types of mold by providing an apparatus for the injection-molding of containers made of thermoplastic material, particularly single-dose containers for fluid products, which allows effective centering of the male plug with respect to the corresponding female mold part, allows to keep the male plug in aligned configuration during the molding of the containers, to contain the thickness of the interspace formed between the male plug and the female mold part within the intended tolerance range, and to avoid the formation of hollows and cavities in the walls of the containers.

Within this aim, an object of the present invention is to provide a structure which is simple, relatively easy to manufacture, safe in use, effective in operation and relatively low in cost.

This aim and this and other objects are achieved by the present injection-molding apparatus for molding containers made of thermoplastic material, particularly single-dose containers for fluid products, of the type that comprises a structure for supporting a mold constituted by a female mold part and a corresponding male plug which can be coupled axially, an interspace for molding at least one container being formed between the female mold part and the male plug, a circuit for feeding the thermoplastic material which is associated with the mold and is provided with injection means for injecting the material into the interspace, and a circuit for cooling the mold for the setting of the injected material so as to obtain said container, characterized in that it comprises automatic means for centering the male plug with respect to the female mold part which are associated with the mold and operate alternatively.

### BRIEF DESCRIPTION OF THE DRAWINGS

Further characteristics and advantages of the present invention will become better apparent from the detailed description of a preferred but not exclusive embodiment of an apparatus for the injection-molding of containers made of thermoplastic material, particularly single-dose containers for fluid products, illustrated only by way of non-limitative example in the accompanying drawings, wherein:

FIG. 1 is a sectional view of an injection-molding apparatus for molding containers made of thermoplastic material, particularly single-dose containers for fluid products, according to the invention, in the operating configuration;

FIG. 2 is a schematic plan view of a half-mold which constitutes the female mold part of the mold of FIG. 1;

FIG. 3 is a sectional view of the half-mold of FIG. 2;

FIG. 4 is a sectional view of an alternative embodiment of the half-mold of FIG. 2;

FIG. 5 is a sectional view of the male plug of the mold of FIG. 1.

### DESCRIPTION OF THE PREFERRED EMBODIMENTS

With reference to the figures, the reference numeral 1 generally designates an injection-molding apparatus for molding containers made of thermoplastic material, particularly single-dose containers for fluid products such as, for example, pharmaceutical, medical and cosmetic products.

The apparatus 1 comprises a frame 2 for supporting a mold 3 being constituted by: a female mold part 4 and a corresponding male plug 5 which can be axially coupled one another, an interspace 6 for molding the containers remaining between the female mold part 4 and the male plug 5; and a circuit for feeding the thermoplastic material, which is associated with the mold 3 and is provided with means 7 for injecting the material into the interspace 6.

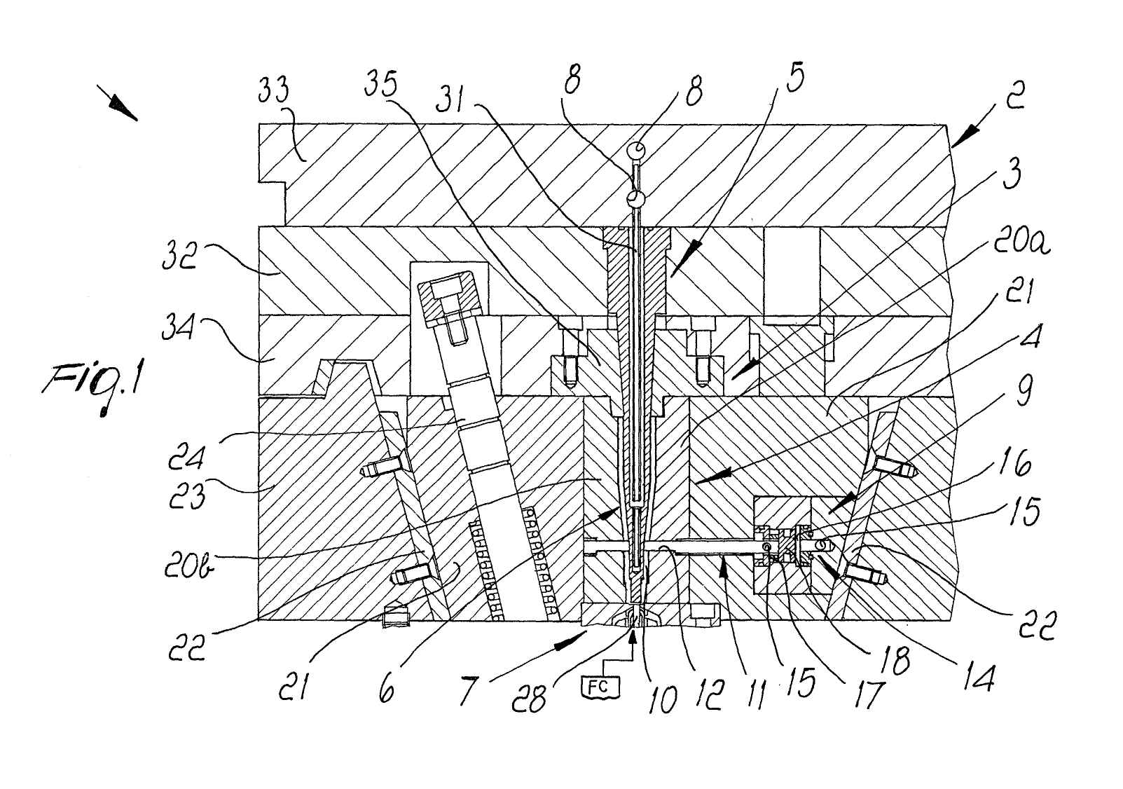

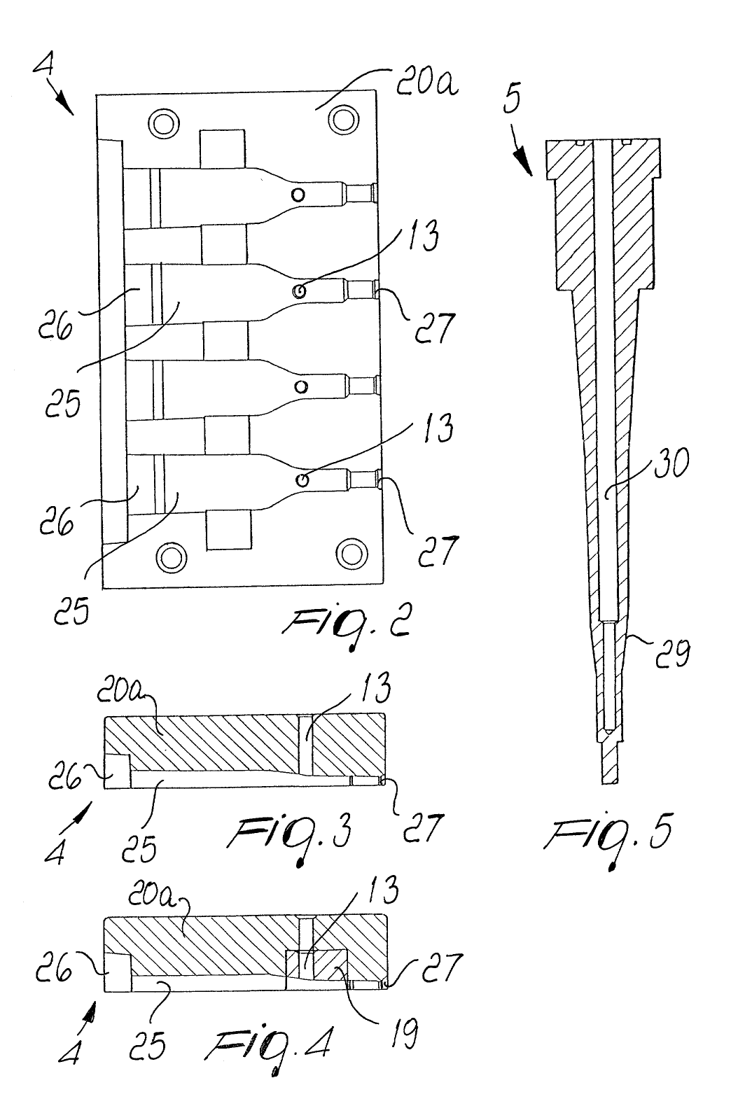

The circuit FC for feeding the mold is only schematically illustrated in FIG. 1, since it is of a conventional type and substantially comprises a hopper for loading the thermoplastic material and an injection assembly in which the material is heated, brought to the plastic state, and then fed to the injection means 7, which introduce it in the interspace 6.

The apparatus 1 also comprises a mold cooling circuit, which is of a conventional type and is schematically represented by the cooling fluid inlet and outlet ports 8; the cooling of the mold 3 allows the setting of the injected material in order to obtain the intended container.

The apparatus 1 is provided with automatic centering means or elements 9 for centering the male plug 5 with respect to the female mold part 4; said means are associated with the mold 3 and operate alternatively with respect to the injection of the thermoplastic material in the interspace 6 of the mold.

The shape and thickness or width 10 of the interspace 6 substantially correspond to the shape and thickness of the walls of the container to be molded.

The centering means 9 are constituted by two stems 11 which are arranged so that their longitudinal axes are substantially perpendicular to the longitudinal dimension of the male plug 5 and can slide axially with a reciprocating motion.

Each one of the stems 11 has an end 12 which can be inserted in a corresponding centering hole 13, which passes through the female mold part 4, and an opposite end which is associated with respective actuation means 14.

The two holes 13, and therefore the two stems 11, are arranged mutually opposite, at 180° to each other, so as to center and lock symmetrically the male plug 5 with respect to the female mold part 4.

The actuation means 14 are adapted to move each stem 11 alternatively from a retracted inactive configuration, in which the end 12 is inserted in the hole 13 but lies externally to the interspace 6, preserving its continuity, to an extended active configuration, in which the end 12 is inserted in the hole 13 and protrudes into the interspace 6, interrupting its continuity.

In the inactive configuration, the end 12 completes the profile of the internal walls of the female mold part 4 at the hole 13, while in the active configuration the end 12 engages, and is in contact with, the male plug 5, keeping it fixed in a configuration in which it is aligned and centered with respect to the female mold part 4.

The active stroke of the stem 11, i.e. the stroke that the end 12 performs to move from the inactive configuration to the active configuration and vice versa, is equal to the cross-sectional thickness or width 10 of the interspace 6, proximate to the hole 13.

Keeping the stems 11 in the inactive configuration, the female mold part 4 is mated with the male plug 5; the actuation means 14 then actuate the stems 11, making them advance into the active configuration; the respective ends 12 enter the interspace 6 and make contact with the male plug 5, centering it and locking it with respect to the female mold part 4, and in this configuration the continuity of the interspace 6, and therefore of the walls of the container to be molded, is interrupted by the presence of the ends 12.

Keeping the stems 11 in the active configuration, the thermoplastic material to be molded is injected into the interspace 6.

Before the amount of injected material is equal to the total amount of material required to form the container, the residual fraction of material to be introduced being, by way of example, in the order of 10%, the actuation means 14 actuate the stems 11, making them retract into the inactive configuration: the ends 12 retract, thus freeing the interspace 6, and at the same time complete the profile of the internal walls of the female mold part 4 at the holes 13.

In this manner, the continuity of the internal walls of the female mold part 4 and of the interspace 6 is restored, and filling of said interspace is completed by the introduction of the residual fraction of material to be molded.

The operating times and the extent of the stroke of the stem 11 are defined in relation to the thickness or width 10 of the interspace 6, to the method with which the material to be molded is introduced, and to the nature and physical and Theological characteristics of the material.

In particular, the entire molding operation requires times on the order of 15-25 seconds, while the thickness 10 is on the order of 0.05-0.1 mm.

The actuation means 14 are of the hydraulic type and are constituted by a double-acting cylinder, which is associated with the mold 3 and actuates the stem 11, and by a hydraulic circuit of the conventional type, of which only the ports 15 for the intake/discharge of the fluid that acts in the respective working chambers 16 and 17 are shown for the sake of simplicity.

A piston 18 fixed to the end of the stem 11 (arranged opposite the end 12) slides in the cylinder and its outward and return stroke is determined and controlled by the hydraulic circuit.

As an alternative, the actuation means 14 can be of the electric or pneumatic type.

Since the coupling between the end 12 of the stem 11 and the hole 13 must ensure centering, it is provided with a narrow tolerance; accordingly, friction can occur such as to cause rapid wear of said coupled elements, with consequent loss of their functionality. In order to keep the efficiency of the centering means 9 unchanged and at a high level, the holes 13 are advantageously formed in inserts 19 which can be inserted by interlocking in the female mold part 4 (FIG. 4).

In the embodiment shown in the figures, the female mold part 4 is constituted by two half-molds 20a and 20b which are clamped together by an external jacket which is constituted by jaws 21 and is part of the structure 2.

The jaws 21 are coupled externally to inclined planes being constituted by adjustment shims 22 which are fixed to a fixed containment structure 23; each jaw is provided with fixing means 24 which are adapted to keep them in contact with the two half-molds 20a and 20b, clamping them together to mold the containers, and to allow them to slide on the adjustment shims 22 in order to open the female mold part 4 and extract the molded containers.

In each one of the two half-molds 20a and 20b a plurality of cavities 25 are provided, equal in number to the containers produced in each molding cycle; said cavities are complementary one another, so that by clamping together the two half-molds 20a and 20b they define the impression that shapes the outer surface of the containers.

Each cavity 25 has, at one end, an opening 26 for the entry of the corresponding male plug 5 and, at the opposite end, a port 27 for introducing the material to be molded which is connected to the delivery nozzle 28, which is connected to the injection means 7.

The half-molds 20a and 20b are provided with the through centering holes 13 formed at each cavity 25.

The holes 13 are substantially perpendicular with respect to the longitudinal extension of the cavities 25, i.e. to the direction in which the male plugs 5 are inserted in the corresponding impressions formed by the cavities 25. The end 12 of the stems 11 can thus be inserted, and can slide, in said holes.

By clamping together the two half-molds 20a and 20b, each impression formed by corresponding cavities 25 is therefore provided with two holes 13 which are arranged mutually opposite at 180° to each other.

A corresponding male plug 5 can be inserted axially in each cavity (impression) 25, and its outer surface 29 forms the internal surface of the walls of the container.

The male plug 5 is provided with an axial dead hole 30 in which it is possible to insert a duct 31 for the circulation of the coolant, whose flow is controlled by the cooling circuit.

The male plug 5 is rigidly coupled to the supporting plate 32, anchored to a fixing plate 33, which can slide with a reciprocating motion such as to allow the coupling and uncoupling of the female mold part 4 with respect to the male plug 5; both plates 32 and 33 are part of the frame 2.

An extraction plate 34 rests on the supporting plate 32 and is associated with the end of the male plug 5 that remains substantially external to the female mold part 4; the extraction plate 34 is provided with a movable insert 35 which, by sliding along the axial direction of the male plug 5, allows to separate the molded container from the external surface 29 of the male plug 5 to which it continues to adhere.

After closing the female mold part 4, moving the half-molds 20a and 20b mutually closer and clamping them together by means of the jaws 21 fixed by the fixing means 24, the fixing plate 33 moves the male plug 5, inserting it in the female mold part 4, with which it mates.

At this point, the actuation means 14 actuate the stem 11, moving it from the inactive configuration to the extended active configuration, making the stem 11 perform such a stroke that the end 12 enters the interspace 6, performing a movement equal to the thickness 10.

In this manner, the end 12 makes contact with the male plug 5, centering and fixing it with respect to the female mold part 4, but interrupts the continuity of the interspace 6.

The material to be molded is sent by the feeder circuit (FC) to the nozzle 28 and from there injected, by way of the port 27, into the interspace 6.

Before an amount of material equal to the total amount required to mold the container is injected (the introduced amount being preferably in the order of 90% of the total), the actuation means 14 actuate the stem 11, retracting it into the inactive configuration.

The end 12 correspondingly performs a movement equal to the thickness or width 10, retracting from the interspace 6; in this manner, both the continuity of the profile of the internal walls of the female mold part 4 and the continuity of the interspace 6 are restored.

The injection of the residual fraction of material allows to complete the molding of the walls of the container.

This is followed by a pause, during which the coolant fluid circulating in the duct 31 allows the introduced material to set in the intended shape, undergoing any shrinkage in a controlled manner inside said female mold part 4.

The male plug 5 and the female mold part 4 are subsequently uncoupled and the fixing means 24 are released in order to allow the jaws 21 to slide along the adjustment shims 22 (inclined planes) to open the female mold part 4, whose half-molds 20a and 20b move mutually apart.

The molded container continues to adhere to the outer surface 29 of the male plug 5, from which it is separated as a consequence of the axial movement of the insert 35, which is provided with raised portions which push the container, moving it away from said male plug, the entire apparatus 1 being ready for a subsequent molding cycle.

In practice, it has been found that the described invention achieves the intended aim and objects.

The invention thus conceived is susceptible of numerous modifications and variations, all of which are within the scope of the inventive concept.

All the details may further be replaced with other technically equivalent ones.

In practice, the materials used, as well as the shapes and the dimensions, may be any according to requirements without thereby abandoning the scope of the protection of the appended claims.

The disclosures in Italian Patent Application No. MO2000A000025 from which this application claims priority are incorporated herein by reference.

What is claimed is:

1. An injection-molding apparatus for molding containers, made of thermoplastic material, for fluid products, comprising: a mold constituted by a female mold part and a corresponding male plug, said female mold part and male plug being axially coupleable to form an interspace for molding at least one container; a frame for supporting said mold; a feeding circuit for feeding thermoplastic material, said feeding circuit being connectable to said mold and provided with injection means for injecting material into said interspace; a cooling circuit for cooling the mold and providing setting of the injected material so as to form said container; and centering means for automatically centering said male plug with respect to said female mold part, said centering means being operatively associated with said mold to operate in an alternate manner.

2. The apparatus of claim 1, wherein said automatic centering means comprise: at least one stem, which is arranged substantially transversely with respect to a longitudinal extension of said male plug, and is axially slideable, with a reciprocating motion; at least one corresponding centering hole, which is formed through said female mold part and in which said stem is insertable; and actuation means for actuating said stem so as to move alternatively with said reciprocating motion, from a retracted inactive configuration to an extended active configuration, in which said stem engages said male plug.

3. The apparatus of claim 2, wherein said interspace has, proximate to said centering hole, a cross-sectional width to which an active stroke of said stem between said retracted inactive configuration and said extended active configuration, and back, is substantially equal.

4. The apparatus of claim 3, wherein said actuation means are of a hydraulic type.

5. The apparatus of claim 3, wherein said actuation means are of an electric type.

6. The apparatus of claim 2, wherein said female mold part comprises at least one insert which is arranged and interlocked in the female mold part, and in which said centering hole is formed.

7. The apparatus of claim 6, comprising two said centering holes mutually opposite at 180° to each other and two said stems, said stems being each insertable in a respective one of said two through centering holes which are formed in said female mold part.

8. A method for molding containers, made of thermoplastic material, for fluid products, with the injection-molding apparatus of claim 1, comprising the steps of: mating the male plug with the female mold part with the automatic centering means in a retracted inactive configuration; moving the automatic centering mean into an extended active configuration for centering and locking of the male plug with respect to the female mold part; injecting thermoplastic material in the interspace, formed between the female mold part and male plug; returning the automatic centering means into the retracted inactive configuration before an amount of material injected is equal to a total amount of material that corresponds to molding volume of said containers; completing the injection of material; providing setting of the injected material; and uncoupling the male plug and the female mold part in order to extract the molded containers.
